(19) United States
(12) Patent Application Publication
(10) Pub. No.: US 2025/0142423 A1
(43) Pub. Date: May 1, 2025

(54) WIRELESS COMMUNICATION METHOD, USER EQUIPMENT, AND NETWORK DEVICE

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(73) Assignee: GUANGDONG OPPO MOBILE TELECOMMUNICATIONS CORP., LTD., Dongguan (CN)

(21) Appl. No.: 19/005,091

(22) Filed: Dec. 30, 2024

Related U.S. Application Data
(63) Continuation of application No. PCT/CN2022/111575, filed on Aug. 10, 2022.

(51) Int. Cl. H04W 36/00

(52) U.S. Cl. CPC H04W 36/0058; H04W 36/0088

(57) ABSTRACT

A wireless communication method, user equipment, and a network device are provided. The method includes: sending, by first user equipment, first information to a network device, where the first information is used to indicate a first capability of the first user equipment, and the first capability is associated with a combined configuration of a first-type measurement gap and a second-type measurement gap.

### CROSS-REFERENCE TO RELATED APPLICATIONS

This application is a continuation of International Application No. PCT/CN2022/111575, filed on Aug. 10, 2022, the disclosure of which is hereby incorporated by reference in its entirety.

### TECHNICAL FIELD

This application relates to the field of communications technologies, and more specifically, to a wireless communication method, user equipment, and a network device.

### BACKGROUND

A related technology proposes a plurality of types of measurement gaps (MGs, also referred to as measurement intervals), such as a pre-configured measurement gap (pre-MG), a network controlled small gap (NCSG), and multiple concurrent measurement gaps. However, there is currently no suitable solution to how to perform a combined configuration of a plurality of types of measurement gaps.

### SUMMARY

This application provides a wireless communication method, user equipment, and a network device. The following describes the aspects related to this application.

According to a first aspect, a wireless communication method is provided, including: sending, by first user equipment, first information to a network device, where the first information is used to indicate a first capability of the first user equipment, and the first capability is associated with a combined configuration of a first-type measurement gap and a second-type measurement gap.

According to a second aspect, a wireless communication method is provided, including: receiving, by a network device, first information sent by first user equipment, where the first information is used to indicate a first capability of the first user equipment, and the first capability is associated with a combined configuration of a first-type measurement gap and a second-type measurement gap.

According to a third aspect, a wireless communication method is provided, including: receiving, by first user equipment, first information, where the first user equipment has a plurality of pre-configured measurement gaps, and the first information is used to determine activation/deactivation mechanisms of the plurality of pre-configured measurement gaps, where the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

According to a fourth aspect, a wireless communication method is provided, including: sending, by a network device, first information to first user equipment, where the first user equipment has a plurality of pre-configured measurement gaps, and the first information is used to determine activation/deactivation mechanisms of the plurality of pre-configured measurement gaps, where the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

According to a fifth aspect, user equipment is provided, including: a communications module, configured to send first information to a network device, where the first information is used to indicate a first capability of the user equipment, and the first capability is associated with a combined configuration of a first-type measurement gap and a second-type measurement gap.

According to a sixth aspect, a network device is provided, including: a communications module, configured to receive first information sent by first user equipment, where the first information is used to indicate a first capability of the first user equipment, and the first capability is associated with a combined configuration of a first-type measurement gap and a second-type measurement gap.

According to a seventh aspect, user equipment is provided, including: a communications module, configured to receive first information, where the first user equipment has a plurality of pre-configured measurement gaps, and the first information is used to determine activation/deactivation mechanisms of the plurality of pre-configured measurement gaps, where the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

According to an eighth aspect, a network device is provided, including: a communications module, configured to send first information to first user equipment, where the first user equipment has a plurality of pre-configured measurement gaps, and the first information is used to determine activation/deactivation mechanisms of the plurality of pre-configured measurement gaps, where the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

According to a ninth aspect, user equipment is provided, including a memory and a processor, where the memory is configured to store a program, and the processor is configured to invoke the program in the memory, to cause the user equipment to perform the method according to the first aspect or the third aspect.

According to a tenth aspect, a network device is provided, including a memory and a processor, where the memory is configured to store a program, and the processor is configured to invoke the program in the memory, to cause the network device to perform the method according to the second aspect or the fourth aspect.

According to an eleventh aspect, an apparatus is provided, including a processor, configured to invoke a program from a memory to cause the apparatus to perform the method according to any one of the first aspect to the fourth aspect.

According to a twelfth aspect, a chip is provided, including a processor, configured to invoke a program from a memory to cause a device installed with the chip to perform the method according to any one of the first aspect to the fourth aspect.

According to a thirteenth aspect, a computer-readable storage medium is provided, and the computer-readable storage medium stores a program, and the program causes a computer to perform the method according to any one of the first aspect to the fourth aspect.

According to a fourteenth aspect, a computer program product is provided, including a program that causes a computer to perform the method according to any one of the first aspect to the fourth aspect.

According to a fifteenth aspect, a computer program is provided, where the computer program causes a computer to perform the method according to any one of the first aspect to the fourth aspect.

### BRIEF DESCRIPTION OF DRAWINGS

FIG. 1 is a diagram of a system architecture of a communications system to which an embodiment of this application is applicable.

FIG. 2 is an example diagram of a synchronization signal and PBCH block (SSB) measurement method.

FIG. 3 is an example diagram of an NCSG-based measurement method.

FIG. 4 is a schematic flowchart of a wireless communication method according to an embodiment of this application.

FIG. 5 is a schematic flowchart of a wireless communication method according to another embodiment of this application.

FIG. 6 is a schematic diagram of a structure of UE according to an embodiment of this application.

FIG. 7 is a schematic diagram of a structure of a network device according to an embodiment of this application.

FIG. 8 is a schematic diagram of a structure of UE according to another embodiment of this application.

FIG. 9 is a schematic structural diagram of a network device according to another embodiment of this application.

FIG. 10 is a schematic diagram of a structure of an apparatus according to an embodiment of this application.

### DESCRIPTION OF EMBODIMENTS

Embodiments of this application may be applied to various communications systems. For example, embodiments of this application may be applied to a global system for mobile communications (GSM), a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a universal mobile telecommunications system (UMTS), a wireless local area network (WLAN), wireless fidelity (Wi-Fi), and a 5th generation (5G) communications system. Embodiments of this application may be further applied to another communications system, such as a future communications system. The future communications system may be, for example, a 6th generation (6G) mobile communications system, or a satellite communications system.

Conventional communications systems support a limited quantity of connections and are also easy to implement. However, with the development of communications technologies, a communications system may support not only conventional cellular communication but also one or more types of communication in another type. For example, the communications system may support one or more types of the following communication: device-to-device (D2D) communication, machine-to-machine (M2M) communication, machine type communication (MTC), vehicle-to-vehicle (V2V) communication, vehicle-to-everything (V2X) communication, and the like. Embodiments of this application may also be applied to a communications system that supports the foregoing communication manners.

The communications system in embodiments of this application may be applied to a carrier aggregation (CA) scenario, a dual connectivity (DC) scenario, or a standalone (SA) networking scenario.

The communications system in embodiments of this application may be applied to an unlicensed spectrum. The unlicensed spectrum may also be considered as a shared spectrum. Alternatively, the communications system in embodiments of this application may be applied to a licensed spectrum. The licensed spectrum may also be considered as a dedicated spectrum.

Embodiments of this application may be applied to a terrestrial network (TN) system, or may be applied to a non-terrestrial network (NTN) system. As an example, the NTN system may include an NR-based NTN system and an Internet of Things (IoT)-based NTN system.

The communications system may include one or more user equipments (UEs). The UE in embodiments of this application may also be referred to as a terminal device, an access terminal, a user unit, a user station, a mobile site, a mobile station (MS), a mobile terminal (MT), a remote station, a remote terminal, a mobile device, a user terminal, a terminal, a wireless communications device, a user agent, a user apparatus, or the like.

In some embodiments, the UE may be a station (ST) in a WLAN. In some embodiments, the UE may alternatively be a cellular phone, a cordless phone, a session initiation protocol (SIP) phone, a wireless local loop (WLL) station, a personal digital assistant (PDA) device, a handheld device having a wireless communication function, a computing device or any other processing device connected to a wireless modem, a vehicle-mounted device, a wearable device, UE in a next generation communications system (such as an NR system) or UE in a future evolved public land mobile network (PLMN), or the like.

In some embodiments, the UE may be a device providing a user with voice and/or data connectivity. For example, the UE may be a handheld device, a vehicle-mounted device, or the like having a wireless connection function. In some specific examples, the UE may be a mobile phone, a tablet computer, a notebook computer, a palmtop computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, or the like.

In some embodiments, the UE may be deployed on land. For example, the UE may be deployed indoors or outdoors. In some embodiments, the UE may be deployed on water, for example, on a ship. In some embodiments, the UE may be deployed in the air, for example, on an airplane, a balloon, and a satellite.

In addition to the UE, the communications system may further include one or more network devices. The network device in embodiments of this application may be a device for communicating with the UE. The network device may also be referred to as an access network device or a wireless access network device. The network device may be, for example, a base station. The network device in embodiments of this application may be a radio access network (RAN) node (or device) that connects the UE to a wireless network. The access network device may broadly cover the following various names, or may be replaced with the following names: a NodeB, an evolved NodeB (eNB), a next generation NodeB (gNB), a relay station, an access point, a transmitting and receiving point (TRP), a transmitting point (TP), a master eNode MeNB, a secondary eNode SeNB, a multi-standard radio (MSR) node, a home base station, a network controller, an access node, a radio node, an access point (AP), a transmission node, a transceiver node, a baseband unit (BBU), a remote radio unit (RRU), an active antenna unit (AAU), a remote radio head (RRH), a central unit (CU), a distributed unit (DU), a positioning node, and the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in device-to-device D2D, vehicle-to-everything (V2X), and machine-to-machine (M2M) communication, a network-side device in a 6G network, a device that functions as a base station in the future communications system, or the like. The base station may support networks with a same access technology or different access technologies. A specific technology and a specific device form used by the network device are not limited in embodiments of this application.

The base station may be fixed or mobile. For example, a helicopter or an unmanned aerial vehicle may be configured to act as a mobile base station, and one or more cells may move according to a location of the mobile base station. In another example, a helicopter or an unmanned aerial vehicle may be configured to serve as a device in communication with another base station.

In some deployments, the network device in embodiments of this application may be a CU or a DU, or the network device includes a CU and a DU. The gNB may further include an AAU.

By way of example rather than limitation, in embodiments of this application, the network device may have a mobility characteristic. For example, the network device may be a mobile device. In some embodiments of this application, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments of this application, the network device may alternatively be a base station located on land, water, or the like.

In embodiments of this application, the network device may provide a service for a cell, and the UE communicates with the network device by using a transmission resource (for example, a frequency domain resource or a spectrum resource) used by the cell. The cell may be a cell corresponding to the network device (for example, a base station). The cell may belong to a macro base station or belong to a base station corresponding to a small cell. The small cell herein may include: a metro cell, a micro cell, a pico cell, a femto cell, or the like. These small cells have features of a small coverage range and low transmit power, and are suitable for providing a high-rate data transmission service.

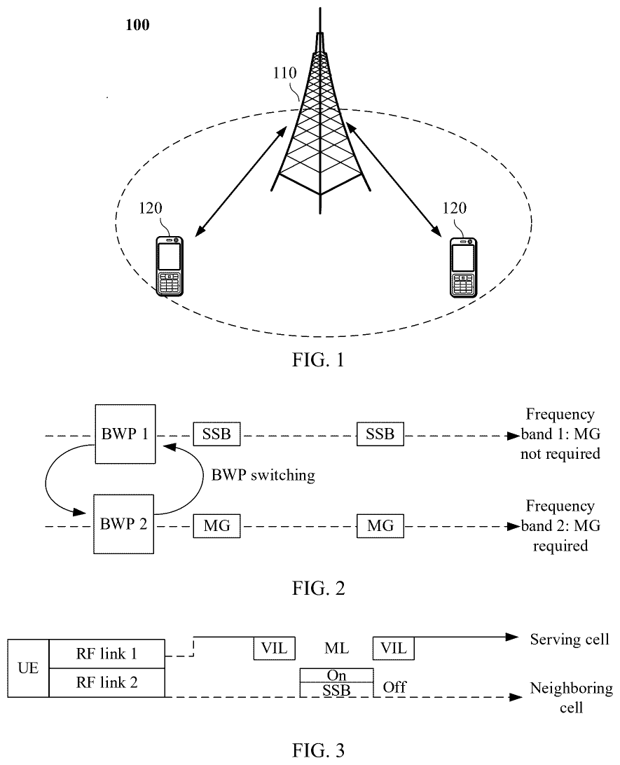

For example, FIG. 1 is a schematic diagram of an architecture of a communications system according to an embodiment of this application. As shown in FIG. 1, a communications system 100 may include a network device 110, and the network device 110 may be a device that communicates with UE 120 (or referred to as a communications terminal or a terminal). The network device 110 may provide communication coverage for a specific geographic area, and may communicate with UE within the coverage area.

FIG. 1 exemplarily shows one network device and two UEs. In some embodiments of this application, the communications system 100 may include a plurality of network devices and another quantity of UEs may be included within a coverage area of each network device, which is not limited in embodiments of this application.

In some embodiments of this application, the wireless communications system shown in FIG. 1 may further include another network entity such as a mobility management entity (MME) or an access and mobility management function (AMF), which is not limited in the embodiment of this application.

It should be understood that in embodiments of this application, a device having a communication function in a network/system may be referred to as a communications device. The communications system 100 shown in FIG. 1 is used as an example. A communications device may include the network device 110 and the UE 120 having a communication function, and the network device 110 and the UE 120 may be specific devices described above, and details are not described herein. The communications device may further include other devices in the communications system 100, such as a network controller, a mobility management entity, and other network entities, which is not limited in embodiments of this application.

In the communications system, the UE usually needs to perform one or more measurement operations. For example, the UE needs to perform one or more of measurement operations such as SSB measurement, channel state information reference signal (CSI-RS) measurement, or positioning reference signal (PRS) measurement. In order to support a measurement operation of UE, some communications systems introduce an MG. Further, with further development of communications technologies, in order to enable the MG to better support a measurement operation of the UE, some communications systems have enhanced the MG in various forms. Some enhancement technologies related to the MG are described below.

### Pre-Configured MG (Pre-MG)

Some communications systems (such as NR) introduce the pre-MG. A main reason for introducing the pre-MG is that when the UE operates in different bandwidth parts (BWP), the UE may have different measurement requirements for SSB measurement (even for a same measurement object). As shown in FIG. 2, when the UE operates in a BWP 1 (corresponding to a frequency band 1), since the frequency domain location of an SSB is located within the BWP 1 and the subcarrier spacing (SCS)/cyclic prefix (CP) of SSB and BWP 1 are the same, the UE can perform SSB measurement without the MG. When the UE is switched from the BWP 1 to a BWP 2 (corresponding to a frequency band 2), since the frequency domain location of the SSB is not within the BWP 2, the UE needs MG to perform SSB measurement, i.e. SSB can only be measured within the MG. There are various ways to switch a BWP. For example, the UE may quickly complete the switching of the BWP based on a timer or based on downlink control information (DCI). In earlier versions of a protocol (such as Release 16), configuration and release of the MG needs to be completed through RRC signalling, which has a relatively large delay. In order to enable the configuration of the MG to be adaptively adjusted quickly with the switching of the BWP, some versions of the protocol (such as Release 17) have enhanced the MG, introduced the pre-MG, and introduced a mechanism for activating/deactivating the pre-MG with the switching of the BWP.

The foregoing description is made mainly by using SSB measurement as an example, because in related protocols, a condition for determining whether SSB measurement (whether intra-frequency measurement or inter-frequency measurement) requires the MG is whether the frequency domain location of the SSB is located within a BWP currently activated by the UE. Therefore, for the SSB measurement, requirements of the UE for the MG may also change with the switching of the BWP. CSI-RS measurement and PRS measurement do not have the foregoing characteristics of the SSB measurement. For example, for the CSI-RS measurement, if the UE performs the intra-frequency measurement, there is no need to configure the MG for the UE; and if the UE performs the inter-frequency measurement, the MG needs to be configured for the UE. For another example, for the PRS measurement, the MG always needs to be configured for the UE. It can be learned that when the UE needs to perform the PRS measurement and/or inter-frequency CSI-RS measurement, the pre-MG always needs to be activated and cannot be dynamically changed with the switching of the BWP. In this case, the network device may choose to configure a common MG for the UE, or may configure, for the UE, a pre-MG that is always in an activated state.

There are mainly two types of activation/deactivation mechanisms for the pre-MG: one is a network device controlled activation/deactivation mechanism and the other is a UE-autonomous activation/deactivation mechanism. The two activation/deactivation mechanisms correspond to two different capabilities of the UE. For a detailed description to the two capabilities, refer to related proposals or documents. For example, the proposal R4-2210436 describes the two capabilities of the UE. The first capability is identified by “19-3-1” in R4-2210436, and is a pre-MG with network device controlled activation/deactivation mechanism. The second capability is identified by “19-3-2” in R4-2210436, and is a pre-MG with UE autonomous activation/deactivation mechanism. If the UE supports at least one of the two capabilities, the network device may configure a pre-MG for the UE. If the UE supports both of the two capabilities, that is, the UE supports both of the two activation/deactivation mechanisms of pre-MGs, when the network device configures activation/deactivation indication information of pre-MGs, a network device controlled activation/deactivation mechanism may be used preferentially.

The network device currently implements the network controlled activation/deactivation mechanism based on configuration of a BWP. Specifically, the network device adds a deactivated MG set in the configuration of the BWP to indicate to the UE that MGs in the deactivated MG set can be deactivated when switching is made to the BWP, and MGs not belonging to the deactivated MG set can be in an activated state by default. The deactivated MG set is usually presented in a form of a list, so that the deactivated MG set may also be referred to as a deactivated MG list. A form of the deactivated MG list provided by Release 17 is as follows:
deactivatedMeasGapList-r17 SEQUENCE (SIZE (1..maxNrofGapId-r17)) OF MeasGapId-r17 OPTIONAL, —Cond PreConfigMG

In addition to the pre-MGs mentioned above, there are other types of pre-MGs, such as an enhanced positioning pre-MG (ePOS pre-MG). The enhanced positioning pre-MG and the pre-MGs mentioned above are similar. For the pre-MGs, the network device pre-configures one or some MGs. Then, in a case of triggering by some conditions or signalling, the pre-configured MGs may be quickly activated/deactivated. Different from the pre-MGs mentioned above, the enhanced positioning pre-MG is an MG introduced specifically for the PRS measurement, and an activation/deactivation method of the enhanced positioning pre-MG is also different from that of the pre-MG mentioned above. For example, the enhanced positioning pre-MG may be activated/deactivated through a medium access control element (MAC CE).

### Multiple Concurrent MGs

In earlier versions of a communication protocol (such as Release 16), UE may only use one MG or two MGs when performing radio resource management (RRM)/positioning measurement. Whether the UE uses one MG or two MGs depends on a capability of the UE. For example, if the UE supports a per frequency range (per-FR) MG (per-FR MG, also referred to as per-FR gap), one MG pattern (MGP) may be configured on each of an FR1 and an FR2. For another example, if the UE supports per-UE MG (per-UE MG, also referred to as per-UE gap), only one MG pattern can be configured for the UE.

When the UE needs to perform SSB measurement at a plurality of frequencies (different frequencies correspond to different SSB measurement timing configuration (SMTC) windows), or when the UE needs to measure a plurality of different signals (such as an SSB, a CSI-RS, and a PRS), configuring only one MG pattern for the UE (or one MG pattern is configured for one FR) may not be able to include all signals in the MG, which may cause some signals cannot be accurately measured or cause a waste of MGs.

To resolve the foregoing problem, some versions of the communication protocol (such as Release 17) introduce a plurality of simultaneous and independent MG patterns. The plurality of simultaneous and independent MG patterns may be referred to as multiple concurrent MGs, or concurrent MGs for short. Introduction of concurrent MGs helps UE to better complete a measurement operation under different SMTC configurations, and/or in measurement scenarios of a plurality of different signals (such as an SSB, a CSI-RS, and a PRS), and/or in scenarios of measuring different radio access technologies (RAT). The radio access technologies may include, for example, evolved universal terrestrial radio access (E-UTRA) and NR.

In order to better allocate different measurement operations/objects to different MGs, some versions of the communication protocol (such as Release 17) support indicating, in a measurement configuration, an MG associated with the measurement configuration. In addition, in order to resolve a case in which a plurality of MGs may overlap (or conflict) in time, a concept of a priority (for example, the priority may be included in a configuration of the MG) may be introduced to discard an MG with a lower priority in the conflicting MGs.

Whether the UE supports concurrent MGs is also a capability of the UE. For a detailed description to the capability, refer to related proposals or documents. For example, the proposal R4-2210436 describes the capability of the UE. The capability is identified by “19-2” in R4-2210436. In addition, the fact that UE supports concurrent MGs does not mean that any quantity of MGs may be configured for the UE. There is a specific limitation on a quantity of MGs configured in terms of concurrent MGs. For example, for UE that does not support a per-FR MG, currently only two per-UE MGs can be configured at most, while for UE that supports a per-FR MG capability, a configuration of concurrent MGs that the UE can support may be seen in Table 1 below.

TABLE 1
Quantity of gap combination configurations for UE supporting
both a concurrent MG patterns and an independent MG pattern

| Gap | | | |
|---|---|---|---|
| combination | | | |
| configuration | Quantity of MG patterns configured simultaneously | | |
| identity | Per-FR1 MG | Per-FR2 MG | Per-UE MG |
| 0 | 2 | 1 | 0 |
| 1 | 1 | 2 | 0 |
| 2 | 0 | 0 | 2 |
| 3 | 1 | 0 | 1 |
| 4 | 0 | 1 | 1 |
| 5 | 1 | 1 | 1 |
| 6 | 2 | 0 | 0 |
| 7 | 0 | 2 | 0 |

It should be noted that gap combination configuration identities 3, 4, and 5 in Table 1 may be only applied when a per-UE MG is associated with PRS measurement for any of RSTD, PRS-RSRP, and UE Rx-Tx time difference measurement defined in TS 38.215 NCSG

Compared with an MG, the NCSG can reduce an interruption time required for measurement. A typical NCSG scenario is shown in FIG. 3. As shown in FIG. 3, in the NCSG scenario, UE may use idle radio frequency chain (RF chain) resources to perform neighboring cell measurement, and using a measurement length (ML) may not cause a long interruption time. In addition, based on the NCSG, measurement and data transmission and reception in a serving cell can be maintained at the same time, and only a relatively short visible interruption length (VIL) is required before and after the measurement. Since an NCSG pattern is somewhat different from a pattern of a common MG, the NCSG pattern is defined in some protocols (such as Table 9.1.9.3-1 of TS 38.133), which includes a visible interruption repetition period (VIRP) and an ML.

The NCSG has a limitation on a measurement object. For example, one or more of the following measurements may be performed based on the NCSG: intra-frequency/inter-frequency SSB measurement, deactivated or dormant secondary cell measurement, or cross-system E-UTRAN measurement. However, some measurements do not support use of the NCSG, and such measurements may include, for example, PRS measurement and inter-frequency CSI-RS measurement.

In addition, for the NCSG, UE needs to support some new capabilities. For a detailed description to related capabilities, refer to related proposals or documents. For example, the proposal R4-2210436 describes the capabilities that the UE needs to support when using the NCSG. For details, refer to the section 19-1 of R4-2210436. For example, “19-1” in R4-2210436 introduces a capability of supporting a network controlled NCSG. “19-1-1” in R4-2210436 introduces support of a per-FR NCSG. If the UE does not support a per-FR NCSG, only a per-UE NCSG can be configured for the UE by default. In addition to the foregoing two capabilities, “19-1-2” in R4-2210436 is used by the UE to report an NCSG pattern that is supported by the UE, and “19-1-3” is used by the UE to report an NCSG pattern that is supported by the UE for NR-only measurement.

### MG Enhanced Combination

It has been mentioned above that a variety of MG enhancement solutions, and the solutions enhance MGs from a plurality of directions. In terms of complexity of standardization, before Release 17, enhancement is performed separately only in a plurality of enhancement directions of MGs, and a scenario of combining the plurality of enhancement solutions is not considered. For example, when concurrent MGs are used, each MG in the concurrent MGs is assumed to be a common MG instead of a pre-configured MG or an NCSG by default. In Release 18, further consideration may be given to how to perform combination different MG enhancement schemes. A project description of related projects of Release 18 is provided below. It may be learned from the following project description that two typical scenarios of MG enhancement combination are to configure one or more MGs in concurrent MGs as pre-configured MGs/NCSGs.

### Enhancements of Pre-Configured MGs, Multiple Concurrent MGs, and NCSGs.

1. RRM requirements for UEs configured with a combination of pre-configured MGs, and/or multiple concurrent MGs and/or NCSG are defined [RAN4].

2. Joint requirements of UE configured with a case 1 and configured with a case 2 are prioritized:
Case 1: Pre-configured MGs and multiple concurrent MGs (that is, concurrent MGs where at least one MG is a pre-configured MG);
Case 2: NCSGs and multiple concurrent MGs (that is, concurrent MGs where at least one MG is an NCSG).

Note: Prioritization among other possible combinations of pre-configured MGs, concurrent MGs, and NCSGs can be discussed in a WI phase.

Although a current protocol proposes to combine a plurality of MG enhancement features, there is currently no suitable solution to how to combine a plurality of MG enhancement features.

A careful study of MG enhancement solutions such as a pre-configured MG, multiple concurrent MGs, and an NCSG shows that each enhancement solution requires the UE to have a corresponding capability support. Therefore, when the plurality of MG enhancement features are combined, it should also be determined whether the UE has a corresponding capability. Otherwise, if the network device performs a combined configuration of the plurality of MG enhancement features, but the UE cannot use the combined configuration, this may cause a problem of a configuration resource waste.

Embodiments of this application are described in detail below with reference to the accompanying drawings.

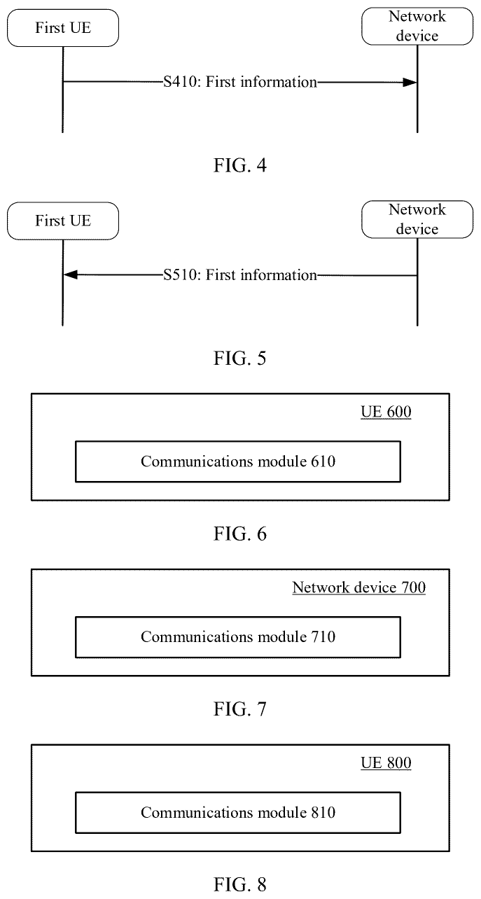

FIG. 4 is a schematic flowchart of a wireless communication method according to an embodiment of this application. The method shown in FIG. 4 is described from a perspective of interaction between first UE and a network device. The first UE and the network device may be any type of UE and network device mentioned above.

Referring to FIG. 4, in Step S410, the first UE sends first information to the network device. The first information may be used to indicate a first capability of the first UE (or the first information may be information associated with the first capability). The first capability may be associated with a combination of a first-type MG and a second-type MG. Alternatively, the first capability may be associated with a combined configuration of a first-type MG and a second-type MG.

In some embodiments, the first information may be referred to as capability information of the first UE. That the first UE sends first information to the network device may include: The first UE sends a capability reporting message to the network device, where the capability reporting message carries the capability information.

In some embodiments, the first-type MG and the second-type MG may be understood as MGs in different configurations. Therefore, in this embodiment, the first-type MG and the second-type MG may also be referred to as a first-type MG configuration and a second-type MG configuration respectively.

In some embodiments, the first-type MG may correspond to an enhancement feature of an MG. The second-type MG may correspond to another enhancement feature of the MG.

In some embodiments, the first-type MG or a gap configured based on the first-type MG may be a per-UE MG or a per-FR MG (such as a per-FR1 MG or a per-FR2 MG).

In some embodiments, the second-type MG or a gap configured based on the second-type MG may be a per-UE MG or a per-FR MG (such as a per-FR1 MG or a per-FR2 MG).

In some embodiments, the first-type MG includes a pre-MG and/or an NCSG, and the second-type MG includes concurrent MGs. For example, the first-type MG is a pre-MG, and the second-type MG is concurrent MGs. For another example, the first-type MG is an NCSG, and the second-type MG is concurrent MGs. For another example, the first-type MG includes a pre-MG and an NCSG, and the second-type MG is concurrent MGs.

In some embodiments, the first-type MG includes a pre-MG, and the second-type MG includes an NCSG.

In some embodiments, the first-type MG includes an NCSG, and the second-type MG includes a pre-MG.

In some embodiments, the first-type MG includes a pre-MG for positioning (activated/deactivated by a MAC CE), and the second-type MG includes an NCSG.

In some embodiments, the first-type MG and/or the second-type MG may alternatively be other enhanced MG types or new MGs introduced in later versions of the protocol.

Embodiments of this application introduce, to the first UE, a capability (that is, the first capability mentioned above) of associating with a combination or a combined configuration of a plurality of types of MGs. On this basis, the first UE indicates the first capability to the network device through the first information, to help the network device to properly configure measurement gaps of the first UE.

As mentioned above, the first capability is a capability associated with the combination (or combined configuration) of the first-type MG and the second-type MG. Embodiments of this application impose no limitation on specific content of the first capability, and may be any type of capability that is helpful for the combination (or combined configuration). For example, the first capability may be used to report, to the network device, one or more of a quantity, a type, a combination, or the like of the first-type MGs supported and configured for the first UE. After learning the first capability of the first UE, the network device may configure a proper MG for the first UE based on the first capability. As an example, the first capability may be a capability indicating whether the UE supports a combined configuration. Alternatively, the first capability may be a capability indicating which types of measurement gaps can be supported by the UE for combination. Alternatively, the first capability may be a capability indicating which specific configurations in the combined configuration are supported by the UE. Alternatively, the combined configuration may have a plurality of configuration parameters, and the first capability may be a capability indicating which parameter or parameters are supported by the UE, or indicating that the UE supports a specific value of a specific parameter.

The first information may be used to indicate the first capability. If a definition of the first capability is different, content of the first information may also be different, and embodiments of this application do not specifically limit this. Optionally, the first information may be used by the network device to determine a combined configuration supported by the first UE. For example, the first information may be used by the network device to determine one or more of the following information associated with the combined configuration: a quantity of first-type MGs, a quantity of second-type MGs, a per-FR capability, a type of the combined configuration (specific types of measurement gaps that are combined), an activation/deactivation mechanism of a pre-MG in the combined configuration (when a pre-MG is included in the combined configuration), or the like.

In some embodiments, the first information may include one or more of second information to fifth information mentioned below. The content of the first information is described in detail below by using the second information to the fifth information as an example. It should be understood that the first information to the fifth information mentioned in embodiments of this application may all be replaced by signalling or messages. Alternatively, the first information to the fifth information mentioned in embodiments of this application may all be carried in the same or different signalling or messages.

### Example 1: The First Information Includes the Second Information, that is, Information Used to Indicate or Determine Whether the Combined Configuration is Executable for the First UE

In some embodiments, the second information may directly indicate whether the first UE supports the combined configuration of the first-type MG and the second-type MG.

As an example, the first-type MG is a pre-configured gap, and the second-type MG is concurrent MGs. Anew capability may be set, such as simPreGapAndConcurrentGap. The second information may indicate whether a value of simPreGapAndConcurrentGap is true or false. When the value of simPreGapAndConcurrentGap is true, it means that the first UE supports the combined configuration of the first-type MG and the second-type MG. When the value of simPreGapAndConcurrentGap is false, it means that the first UE does not support the combined configuration of the first-type MG and the second-type MG.

As another example, the first-type MG is an NCSG, and the second-type MG is concurrent MGs. A new capability may be set, such as simNCSGAndConcurrentGap. The second information may indicate whether a value of simNCSGAndConcurrentGap is true or false. When the value of simNCSGAndConcurrentGap is true, it means that the first UE supports the combined configuration of the first-type MG and the second-type MG. When the value of simNCSGAndConcurrentGap is false, it means that the first UE does not support the combined configuration of the first-type MG and the second-type MG.

As still another example, the first-type MG includes a pre-configured gap and an NCSG, and the second-type MG is concurrent MGs. A new capability may be set, such as simPreGapAndNCSGAndConcurrentGap. The second information may indicate whether a value of simPreGapAndNCSGAndConcurrentGap is true or false. When the value of simPreGapAndNCSGAndConcurrentGap is true, it means that the first UE supports the combined configuration of the first-type MG and the second-type MG. When the value of simPreGapAndNCSGAndConcurrentGap is false, it means that the first UE does not support the combined configuration of the first-type MG and the second-type MG.

In some embodiments, the second information may indirectly or implicitly indicate whether the first UE supports the combined configuration of the first-type MG and the second-type MG. For example, the second information may separately indicate that the first UE supports the first-type MG and the second-type MG (it should be understood that in this example, the second information may include a plurality of types of information, and the plurality of types of information may be reported to the network device at one time or separately). If the first UE supports each of the first-type MG and the second-type MG, it may be considered that the first UE supports the combined configuration of the first-type MG and the second-type MG. If the first UE does not support the first-type MG or does not support the second-type MG, it may be considered that the first UE does not support the combined configuration of the first-type MG and the second-type MG. An implementation of the second information provided in this embodiment does not require new signalling to be set for the UE to support reporting of the second information, which can reduce air interface overheads.

As an example, the first-type MG is a pre-configured gap, and the second-type MG is concurrent MGs. If the second information indicates that the first UE supports a pre-configured gap, and the second information indicates that the first UE supports concurrent MGs, it may be considered that the first UE supports the combined configuration of the first-type MG and the second-type MG. If the second information indicates that the first UE does not support a pre-configured gap, or the second information indicates that the first UE does not support concurrent MGs, it may be considered that the first UE does not support the combined configuration of the first-type MG and the second-type MG.

As another example, the first-type MG is an NCSG, and the second-type MG is concurrent MGs. If the second information indicates that the first UE supports an NCSG, and the second information indicates that the first UE supports concurrent MGs, it may be considered that the first UE supports the combined configuration of the first-type MG and the second-type MG. If the second information indicates that the first UE does not support an NCSG, or the second information indicates that the first UE does not support concurrent MGs, it may be considered that the first UE does not support the combined configuration of the first-type MG and the second-type MG.

As still another example, the first-type MG includes a pre-MG and an NCSG, and the second-type MG is concurrent MGs. If the second information indicates that the first UE supports each of a pre-MG, an NCSG, and concurrent MGs, it may be considered that the first UE supports the combined configuration of the first-type MG and the second-type MG. If the second information indicates that the first UE does not support a pre-MG, or the second information indicates that the first UE does not support concurrent MGs, or the second information indicates that the first UE does not support an NCSG, it may be considered that the first UE does not support the combined configuration of the first-type MG and the second-type MG.

As still another example, the first-type MG includes a pre-MG and an NCSG, and the second-type MG is concurrent MGs. If the second information directly indicates that the first UE supports both a pre-MG and concurrent MGs (for example, reference may be made to simPreGapAndConcurrentGap above), and the second information directly indicates that the first UE supports both an NCSG and concurrent MGs (for example, reference may be made to simNCSGAndConcurrentGap above), it may be considered that the first UE supports the combined configuration of the first-type MG and the second-type MG. If the second information indicates that the first UE does not support a pre-MG and concurrent MGs at a time, or the second information indicates that the first UE does not support an NCSG and concurrent MGs at a time, it may be considered that the first UE does not support the combined configuration of the first-type MG and the second-type MG.

In some embodiments, the second information may be a combination of any information listed above. For example, the second information may include one or more of the following information that the first UE supports a pre-MG; the first UE supports an NCSG; the first UE supports concurrent MGs; the first UE supports both a pre-MG and concurrent MGs; the first UE supports both an NCSG and concurrent MGs; or the first UE supports all of a pre-MG, an NCSG, and concurrent MGs.

In some embodiments, if the first-type MG includes a plurality of types of MGs, the second information may indicate that the first UE may support a plurality of MGs, and some or all of the plurality of MGs have a one-to-one correspondence with the plurality of types of MGs. For example, the first-type MG includes a pre-MG and an NCSG, and the second information may indicate that the first UE supports a plurality of MGs, the plurality of MGs include a first MG and a second MG, the first MG is a pre-MG, and the second MG is an NCSG.

In some embodiments, if the first-type MG includes a plurality of types of MGs, the second information may indicate that the first UE may support one or more MGs, and an MG in the one or more MGs is simultaneously the plurality of types of MGs. For example, the first-type MG includes a pre-MG and an NCSG, and the second information may indicate that the first UE supports a plurality of MGs, the plurality of MGs include a first MG, the first MG is a pre-MG, and the first MG is an NCSG.

After receiving the second information, the network device may determine whether the combined configuration of the first-type MG and the second-type MG is executable for the first UE. Then, the network device may configure both the first-type MG and the second-type MG for the first UE. There may be a plurality of ways to configure both the first-type MG and the second-type MG, and a plurality of examples are given below.

For example, a first-type measurement configuration includes a pre-configured measurement configuration, and a second-type measurement configuration includes a concurrent measurement configuration. The network device may configure one or more MGs in the configurations shown in Table 1 as the pre-configured measurement configuration. For example, referring to Table 1, a configuration 0 includes two per-FR1 MGs and one per-FR2 MG, and the network device may configure one of the MGs as the pre-configured measurement configuration.

For example, the first-type measurement configuration includes a pre-configured measurement configuration, and the second-type measurement configuration includes a concurrent measurement configuration. The network device may add a pre-MG based on the configurations shown in Table 1. For example, referring to Table 1, a configuration 0 includes two per-FR1 MGs and one per-FR2 MG, and the network device may add a per-FR2 pre-MG based on the per-FR2 MG.

For example, the first-type measurement configuration includes an NCSG, and the second-type measurement configuration includes a concurrent measurement configuration. The network device may configure one or more MGs in the configurations shown in Table 1 as the NCSG. For example, referring to Table 1, a configuration 0 includes two per-FR1 MGs and one per-FR2 MG, and the network device may configure one of the MGs as the NCSG.

For example, the first-type measurement configuration includes an NCSG, and the second-type measurement configuration includes a concurrent measurement configuration. The network device may add an NCSG based on the configurations shown in Table 1. For example, referring to Table 1, a configuration 0 includes two per-FR1 MGs and one per-FR2 MG, and the network device may add an NCSG based on the per-FR2 MG.

### Example 2: The First Information Includes the Third Information, that is, Information Used to Indicate or Determine a Quantity of First-Type MGs Configured for the First UE

In some embodiments, the third information may be used to determine a maximum quantity of first-type MGs configured for the first UE. That is, the third information may be used to determine a quantity of first-type MGs that can be configured for the first UE at most. For example, the first-type MG is a pre-MG. A quantity of pre-configured gaps that can be configured for the first UE at most may be determined based on the third information. For example, the first-type MG is an NCSG. A quantity of NCSGs that can be configured for the first UE at most may be determined based on the third information.

In some embodiments, the third information may be used to indicate a quantity of first-type MGs supported by the first UE. The quantity of first-type MGs may be a per-UE quantity. In other words, statistics on the quantity of first-type MGs may be collected on a per-UE basis. The quantity of first-type MGs may alternatively be a per-FR quantity. In other words, statistics on the quantity of first-type MGs may be collected on a per-FR basis.

In some embodiments, the third information may be used to indicate a maximum quantity of first-type MGs supported by the first UE. The maximum quantity mentioned herein may be a per-UE maximum quantity. In other words, statistics on the maximum quantity may be collected on a per-UE basis.

In some embodiments, the third information may be used to indicate a maximum quantity of first-type MGs supported by the first UE. The maximum quantity mentioned herein may be a per-FR maximum quantity. In other words, statistics on the maximum quantity may be collected on a per-FR basis. For example, the third information may indicate one or more of the following: for an FR1, a quantity of first-type MGs that can be configured for the UE at most; or for an FR2, a quantity of first-type MGs that can be configured for the UE at most. If statistics are collected on a per-FR basis, the first UE needs to support a per-FR capability. The per-FR capability of the first UE may be an explicitly indicated capability or a capability by default. For example, the first-type MG is a pre-MG. Release 17 does not introduce a per-FR pre-MG capability. By default, when the UE supports a per-FR capability and a pre-MG capability, the UE also supports the per-FR pre-MG capability.

In some embodiments, the maximum quantity of first-type MGs supported by the first UE may further include a combination of the foregoing two cases. For example, the third information may include both the per-UE maximum quantity and the per-FR maximum quantity.

In some embodiments, if the first-type MG is a pre-MG, the foregoing quantity may alternatively be a quantity of simultaneously activated MGs (pre-configured but not activated MGs may not be included).

### Example 3: The First Information Includes the Fourth Information, that is, Information Used to Indicate or Determine a Combined Configuration of the First-Type MG and the Second-Type MG

In some embodiments, the second-type MG may include one or more configurations. The fourth information may be used to indicate a target configuration in the one or more configurations. For example, the second-type MG is concurrent MGs. It may be learned from Table 1 above that the second-type MG includes eight configurations. The fourth information may indicate one or more configurations in a configuration of concurrent MGs as the target configuration.

In some embodiments, the target configuration may be understood as a configuration in which the first UE supports introducing of the first-type MG. For example, the first-type MG is a pre-MG and/or an NCSG, and the second-type MG is concurrent MGs. It is assumed that the fourth information indicates the configuration 0 in Table 1, and then it may indicate that the first UE supports introducing of a pre-MG and/or an NCSG to the configuration 0. After receiving the fourth information, the network device may configure some or all MGs in the configuration 0 as pre-MGs and/or NCSGs, or may add a new MG to the configuration 0 as a pre-MG and/or an NCSG.

In some embodiments, the second-type MG may include one or more configurations, and some or all of the one or more configurations are the combined configuration of the first-type MG and the second-type MG. Further, the fourth information may directly indicate one or more combined configurations in the combined configuration as the target configuration. For example, the first-type MG is a pre-MG and/or an NCSG, and the second-type MG is concurrent MGs. Table 1 may be expanded by adding the first-type MG to some configurations in Table 1, or a new configuration option may be added. The new configuration option is an option supporting a combined configuration. Then, the first UE may select a target configuration from the configuration option supporting the combined configuration, and then indicate the target configuration to the network device through the fourth information.

In some embodiments, the fourth information may alternatively be used to indicate a quantity of first-type MGs. For example, the target configuration is a configuration in which the first UE supports introducing of the first-type MG. The “quantity of first-type MGs” may be a quantity of first-type MGs that need to be introduced to the target configuration.

In some embodiments, the fourth information may alternatively be used to indicate that the first-type MG is a per-FR MG and/or a per-UE MG. For example, the target configuration is a configuration in which the first UE supports introducing of the first-type MG. That “the first-type MG is a per-FR MG and/or a per-UE MG” may mean that the first-type MG introduced to the target configuration is a per-FR MG or a per-UE MG.

In some embodiments, if the first UE does not support a per-FR MG (for example, the first UE does not have a per-FR MG capability), MGs in the target configuration are all per-UE MGs. The MG may include a plurality of MGs, and the fourth information indicates that some or all of the plurality of MGs are first-type MGs. For example, the second-type MG is concurrent MGs. If the first UE does not support a per-FR MG, a configuration of concurrent MGs is a combination of two per-UE MGs. In this case, the fourth information may indicate that a quantity of first-type MGs is 1 or 2. If the quantity of first-type MGs is 1, it indicates that the first UE supports a combination of one first-type MG and one common MG. If the quantity of first-type MGs is 2, it indicates that the first UE supports a combination of two first-type MGs.

In some embodiments, fallback may be performed on the target configuration indicated by the fourth information. For example, the first-type MG is a pre-MG or an NCSG, and the second-type MG is concurrent MGs. If the fourth information indicates that the first UE supports configuring of two MGs in the concurrent MGs as a pre-MG or an NCSG, in some cases, only one MG in the concurrent MGs can be configured as a pre-MG or an NCSG. As a specific example, it is assumed that the first UE does not support a per-FR MG (for example, the first UE does not have a per-FR MG capability), and the fourth information indicates that the first UE supports configuring of two per-UE MGs in the concurrent MGs as pre-MGs. In some cases, only one MG in the concurrent MGs can be configured as a pre-MG.

In some embodiments, the fourth information may include a plurality of pieces of indication information. The plurality of pieces of indication information has a one-to-one correspondence with a plurality of configurations included in the second-type measurement configuration. Each of the plurality of pieces of indication information may be used to indicate whether a configuration corresponding to the piece of indication information belongs to the target configuration. Further, in some embodiments, the fourth information may be a bitmap, and accordingly, each piece of indication information in the fourth information may be of one bit.

For example, the first-type MG is a pre-MG, and the second-type MG is concurrent MGs. The second-type MG may include eight configurations shown in Table 1 above. The fourth information may be a bitmap with a length of 8, and eight bits in the bitmap have a one-to-one correspondence with the eight configurations in Table 1. If a value of a specific bit is 1, it may indicate that the first UE supports introducing of a pre-MG to a configuration corresponding to the bit.

For example, the first-type MG is an NCSG, and the second-type MG is concurrent MGs. The second-type MG may include eight configurations shown in Table 1 above. The fourth information may be a bitmap with a length of 8, and eight bits in the bitmap have a one-to-one correspondence with the eight configurations in Table 1. If a value of a specific bit is 1, it may indicate that the first UE supports introducing of an NCSG to a configuration corresponding to the bit.

For ease of understanding, a capability of the first UE and a way to indicate the combined configuration by the fourth information are described in more detail below with reference to two more specific examples.

### Example 3.1: The First-Type MG is a Pre-MG, and the Second-Type MG is Concurrent MGs

It may be learned from Table 1 that, the gap combination configuration 0 of concurrent MGs (configuration 0 for short) supports two per-FR1 MGs and one per-FR2 MG. For the configuration 0, based on a quantity of pre-MGs supported by the UE, a capability of supporting the following combined configurations may be introduced to the first UE:
(1) per-FR1 pre-MG+per-FR1 MG+per-FR2 MG (one pre-MG);
(2) per-FR1 MG+per-FR1 MG+per-FR2 pre-MG (one pre-MG);
(3) per-FR1 pre-MG+per-FR1 MG+per-FR2 pre-MG (two pre-MGs);
(4) per-FR1 pre-MG+per-FR1 pre-MG+per-FR2 MG (two pre-MGs); and
(5) per-FR1 pre-MG+per-FR1 pre-MG+per-FR2 pre-MG (three pre-MGs).

Correspondingly, if the first UE has the capability of supporting the foregoing combined configurations, one or more of the combined configurations may be indicated to the network device through the fourth information mentioned above.

It may be learned from Table 1 that, the gap combination configuration 1 of concurrent MGs (configuration 1 for short) supports one per-FR1 MG and two per-FR2 MGs. For the configuration 1, based on a quantity of pre-MGs supported by the UE, a capability of supporting the following combined configurations may be introduced to the first UE:
(1) per-FR1 pre-MG+per-FR2 MG+per-FR2 MG (one pre-MG);
(2) per-FR1 MG+per-FR2 MG+per-FR2 pre-MG (one pre-MG);
(3) per-FR1 pre-MG+per-FR2 MG+per-FR2 pre-MG (two pre-MGs);
(4) per-FR1 MG+per-FR2 pre-MG+per-FR2 pre-MG (two pre-MGs); and
(5) per-FR1 pre-MG+per-FR2 pre-MG+per-FR2 pre-MG (three pre-MGs).

Correspondingly, if the first UE has the capability of supporting the foregoing combined configurations, one or more of the combined configurations may be indicated to the network device through the fourth information mentioned above.

It may be learned from Table 1 that, the gap combination configuration 2 of concurrent MGs (configuration 2 for short) supports two per-UE MGs. For the configuration 2, based on a quantity of pre-MGs supported by the UE, a capability of supporting the following combined configurations may be introduced to the first UE:
(1) per-UE pre-MG+per-UE MG (one pre-MG); and
(2) per-UE pre-MG+per-UE pre-MG (two pre-MGs).

Correspondingly, if the first UE has the capability of supporting the foregoing combined configurations, one or more of the combined configurations may be indicated to the network device through the fourth information mentioned above.

It may be learned from Table 1 that, the gap combination configuration 3 of concurrent MGs (configuration 3 for short) supports one per-FR1 MG and one per-UE MG. For the configuration 3, based on a quantity of pre-MGs supported by the UE, a capability of supporting the following combined configurations may be introduced to the first UE:
(1) per-FR1 pre-MG+per-UE MG (one pre-MG);
(2) per-FR1 MG+per-UE pre-MG (one pre-MG); and
(3) per-FR1 pre-MG+per-UE pre-MG (two pre-MGs).

Correspondingly, if the first UE has the capability of supporting the foregoing combined configurations, one or more of the combined configurations may be indicated to the network device through the fourth information mentioned above.

It may be learned from Table 1 that, the gap combination configuration 4 of concurrent MGs (configuration 4 for short) supports one per-FR2 MG and one per-UE MG. For the configuration 4, based on a quantity of pre-MGs supported by the UE, a capability of supporting the following combined configurations may be introduced to the first UE:
(1) per-FR2 pre-MG+per-UE MG (one pre-MG);
(2) per-FR2 MG+per-UE pre-MG (one pre-MG); and
(3) per-FR2 pre-MG+per-UE pre-MG (two pre-MGs).

Correspondingly, if the first UE has the capability of supporting the foregoing combined configurations, one or more of the combined configurations may be indicated to the network device through the fourth information mentioned above.

It may be learned from Table 1 that, the gap combination configuration 5 of concurrent MGs (configuration 5 for short) supports one per-FR1 MG, one per-FR2 MG, and one per-UE MG. For the configuration 5, based on a quantity of pre-MGs supported by the UE, a capability of supporting the following combined configurations may be introduced to the first UE:
(1) per-FR1 pre-MG+per-FR2 MG+per-UE MG (one pre-MG);
(2) per-FR1 MG+per-FR2 pre-MG+per-UE MG (one pre-MG);
(3) per-FR1 MG+per-FR2 MG+per-UE pre-MG (one pre-MG);
(4) per-FR1 pre-MG+per-FR2 pre-MG+per-UE MG (two pre-MGs);
(5) per-FR1 MG+per-FR2 pre-MG+per-UE pre-MG (two pre-MGs);
(6) per-FR1 pre-MG+per-FR2 MG+per-UE pre-MG (two pre-MGs); and
(7) per-FR1 pre-MG+per-FR2 pre-MG+per-UE pre-MG (three pre-MGs).

It may be learned from Table 1 that, the gap combination configuration 6 of concurrent MGs (configuration 6 for short) supports two per-FR1 MGs. For the configuration 6, based on a quantity of pre-MGs supported by the UE, a capability of supporting the following combined configurations may be introduced to the first UE:
(1) per-FR1 pre-MG+per-FR1 MG (one pre-MG); and
(2) per-FR1 pre-MG+per-FR1 pre-MG (two pre-MGs).

Correspondingly, if the first UE has the capability of supporting the foregoing combined configurations, one or more of the combined configurations may be indicated to the network device through the fourth information mentioned above.

It may be learned from Table 1 that, the gap combination configuration 7 of concurrent MGs (configuration 7 for short) supports two per-FR2 MGs. For the configuration 7, based on a quantity of pre-MGs supported by the UE, a capability of supporting the following combined configurations may be introduced to the first UE:
(1) per-FR2 pre-MG+per-FR2 MG (one pre-MG); and
(2) per-FR2 pre-MG+per-FR2 pre-MG (two pre-MGs).

Correspondingly, if the first UE has the capability of supporting the foregoing combined configurations, one or more of the combined configurations may be indicated to the network device through the fourth information mentioned above.

### Example 3.2: The First-Type MG is an NCSG, and the Second-Type MG is Concurrent MGs

In some embodiments, Example 3.2 may provide a combined configuration method similar to Example 3.1, which can be provided simply by replacing all pre-MGs in Example 3.1 with NCSGs.

In some embodiments, considering that an NCSG currently cannot support PRS measurement, and per-UE MGs in a configuration 3/4/5 of concurrent MGs is a configuration introduced for PRS measurement, per-UE MGs in the configuration 3/4/5 of concurrent MGs may not be replaced with NCSGs. Specific combined configurations corresponding to this embodiment are given below.

It may be learned from Table 1 that, the gap combination configuration 0 of concurrent MGs (configuration 0 for short) supports two per-FR1 MGs and one per-FR2 MG. For the configuration 0, based on a quantity of NCSGs supported by the UE, a capability of supporting the following combined configurations may be introduced to the first UE:
(1) per-FR1 NCSG+per-FR1 MG+per-FR2 MG (one NCSG);
(2) per-FR1 MG+per-FR1 MG+per-FR2 NCSG (one NCSG);
(3) per-FR1 NCSG+per-FR1 MG+per-FR2 NCSG (two NCSGs);
(4) per-FR1 NCSG+per-FR1 NCSG+per-FR2 MG (two NCSGs); and
(5) per-FR1 NCSG+per-FR1 NCSG+per-FR2 NCSG (three NCSGs).

Correspondingly, if the first UE has the capability of supporting the foregoing combined configurations, one or more of the combined configurations may be indicated to the network device through the fourth information mentioned above.

It may be learned from Table 1 that, the gap combination configuration 1 of concurrent MGs (configuration 1 for short) supports one per-FR1 MG and two per-FR2 MGs. For the configuration 1, based on a quantity of NCSGs supported by the UE, a capability of supporting the following combined configurations may be introduced to the first UE:
(1) per-FR1 NCSG+per-FR2 MG+per-FR2 MG (one NCSG);
(2) per-FR1 MG+per-FR2 MG+per-FR2 NCSG (one NCSG);
(3) per-FR1 NCSG+per-FR2 MG+per-FR2 NCSG (two NCSGs);
(4) per-FR1 MG+per-FR2 NCSG+per-FR2 NCSG (two NCSGs); and
(5) per-FR1 NCSG+per-FR2 NCSG+per-FR2 NCSG (three NCSGs).

Correspondingly, if the first UE has the capability of supporting the foregoing combined configurations, one or more of the combined configurations may be indicated to the network device through the fourth information mentioned above.

It may be learned from Table 1 that, the gap combination configuration 2 of concurrent MGs (configuration 2 for short) supports two per-UE MGs. For the configuration 2, based on a quantity of NCSGs supported by the UE, a capability of supporting the following combined configurations may be introduced to the first UE:
(1) per-UE NCSG+per-UE MG (one NCSG); and
(2) per-UE NCSG+per-UE NCSG (two NCSGs).

Correspondingly, if the first UE has the capability of supporting the foregoing combined configurations, one or more of the combined configurations may be indicated to the network device through the fourth information mentioned above.

It may be learned from Table 1 that, the gap combination configuration 3 of concurrent MGs (configuration 3 for short) supports one per-FR1 MG and one per-UE MG. For the configuration 3, based on a quantity of NCSGs supported by the UE, a capability of supporting the following combined configuration may be introduced to the first UE:
(1) per-FR1 NCSG+per-UE MG (one NCSG).

Correspondingly, if the first UE has the capability of supporting the foregoing combined configurations, one or more of the combined configurations may be indicated to the network device through the fourth information mentioned above.

It may be learned from Table 1 that, the gap combination configuration 4 of concurrent MGs (configuration 4 for short) supports one per-FR2 MG and one per-UE MG. For the configuration 4, based on a quantity of pre-MGs supported by the UE, a capability of supporting the following combined configuration may be introduced to the first UE:
(1) per-FR2 NCSG+per-UE MG (one NCSG).

Correspondingly, if the first UE has the capability of supporting the foregoing combined configurations, one or more of the combined configurations may be indicated to the network device through the fourth information mentioned above.

It may be learned from Table 1 that, the gap combination configuration 5 of concurrent MGs (configuration 5 for short) supports one per-FR1 MG, one per-FR2 MG, and one per-UE MG. For the configuration 5, based on a quantity of NCSGs supported by the UE, a capability of supporting the following combined configurations may be introduced to the first UE:
(1) per-FR1 NCSG+per-FR2 MG+per-UE MG (one NCSG);
(2) per-FR1 MG+per-FR2 NCSG+per-UE MG (one NCSG); and
(3) per-FR1 NCSG+per-FR2 NCSG+per-UE MG (two NCSGs).

It may be learned from Table 1 that, the gap combination configuration 6 of concurrent MGs (configuration 6 for short) supports two per-FR1 MGs. For the configuration 6, based on a quantity of NCSGs supported by the UE, a capability of supporting the following combined configurations may be introduced to the first UE:
(1) per-FR1 NCSG+per-FR1 MG (one NCSG); and
(2) per-FR1 NCSG+per-FR1 NCSG (two NCSGs).

Correspondingly, if the first UE has the capability of supporting the foregoing combined configurations, one or more of the combined configurations may be indicated to the network device through the fourth information mentioned above.

It may be learned from Table 1 that, the gap combination configuration 7 of concurrent MGs (configuration 7 for short) supports two per-FR2 MGs. For the configuration 7, based on a quantity of NCSGs supported by the UE, a capability of supporting the following combined configurations may be introduced to the first UE:
(1) per-FR2 NCSG+per-FR2 MG (one NCSG); and
(2) per-FR2 NCSG+per-FR2 NCSG (two NCSGs).

Correspondingly, if the first UE has the capability of supporting the foregoing combined configurations, one or more of the combined configurations may be indicated to the network device through the fourth information mentioned above.

### Example 4: The First Information Includes Fifth Information, that is, Information Used to Indicate or Determine Whether to Support Configuring of a Per-FR First-Type MG as the Second-Type MG

That is, “whether to support configuring of a per-FR first-type MG as the second-type MG” may be a separate UE capability. For example, the first-type MG includes an NCSG, and the second-type MG includes concurrent MGs. The fifth information may be used to indicate or determine whether to support configuring of a per-FR NCSG as concurrent MGs.

As described in the foregoing description of a pre-MG, the pre-MG supports a plurality of activation/deactivation mechanisms. The following describes in detail, with reference to FIG. 5, how the first UE should perform an activation/deactivation operation on a plurality of pre-MGs when the plurality of pre-MGs exist.

As mentioned above, when the UE supports both a network device controlled activation/deactivation mechanism and a UE autonomous activation/deactivation mechanism, if the network device indicates an activation/deactivation status of a pre-MG in a BWP through signalling, the activation/deactivation status of the pre-MG is determined based on an indication of the network device, and the UE does not need to determine the activation/deactivation status of the pre-MG based on conditions. Currently, the network device generally indicates the activation/deactivation status of the pre-MG through a deactivated MG list carried in a BWP configuration. Pre-MGs included in the list are considered to be in a deactivated state, while pre-MGs not included in the list are in an activated state by default. Signalling provided by a related technology does not explicitly indicate which activation mechanism the pre-MG should use for activation/deactivation, but implicitly indicates the activation/deactivation mechanism of the pre-MG based on whether the network device configures a deactivated MG list. This means that as long as any BWP configuration carries a pre-MG, it is considered that an activation/deactivation mechanism of the pre-MG is a network device controlled activation/deactivation mechanism.

However, when only a plurality of pre-MGs are configured, how should an activation and deactivation mechanism of each pre-MG be determined is a problem. For example, it is not clearly specified whether activation mechanisms of a plurality of pre-MGs need to be the same.

In view of the foregoing problem, an embodiment of this application is described in detail below with reference to FIG. 5.

FIG. 5 is a schematic flowchart of a wireless communication method according to another embodiment of this application. The method shown in FIG. 5 is described from a perspective of interaction between first UE and a network device. The first UE and the network device may be any type of UE and network device mentioned above.

Referring to FIG. 5, in Step S510, the first UE receives first information. The first UE may have (or be configured with) a plurality of pre-MGs. The first information may be used to determine activation mechanisms of the plurality of pre-MGs. The activation/deactivation mechanisms of the pre-MGs mentioned herein may include the following activation: a UE autonomous activation/deactivation mechanism and a network device controlled activation/deactivation mechanism.

In some embodiments, Step S510 may be performed when the first UE supports all of a plurality of activation/deactivation mechanisms of pre-MGs (for example, the first UE supports both the UE autonomous activation/deactivation mechanism and the network device controlled activation/deactivation mechanism). If the first UE supports only one activation/deactivation mechanism, Step S510 may not be performed, and the plurality of pre-MGs may be directly activated/deactivated according to the activation/deactivation mechanisms.

In some embodiments, the activation/deactivation mechanisms of the plurality of pre-MGs may be a same activation/deactivation mechanism. For example, the activation mechanisms of the plurality of pre-MGs are all network device controlled activation/deactivation mechanisms. For another example, the activation mechanisms of the plurality of pre-MGs are all UE autonomous activation/deactivation mechanisms.

In some embodiments, the activation/deactivation mechanisms of the plurality of pre-MGs may be different activation/deactivation mechanisms. Alternatively, the plurality of pre-MGs have respective corresponding activation/deactivation mechanisms. For example, the plurality of pre-MGs include a first pre-MG and a second pre-MG. An activation/deactivation mechanism of the first pre-MG is a network device controlled activation/deactivation mechanism. An activation/deactivation mechanism of the second pre-MG is a UE autonomous activation/deactivation mechanism.

The first information mentioned above may include configuration information of a BWP. The BWP may be any BWP used by the first UE (such as a BWP that is currently in an activated state). Alternatively, the BWP may be some or all of BWPs configured by the network device for the first UE.

In some embodiments, the configuration information of the BWP may include a first deactivated MG set (such as a first deactivated MG list). MGs in the first deactivated MG set are MGs that need to be deactivated when switching is made to the BWP (or when the BWP is in an activated state). If the first MG set includes one or more MGs in the plurality of pre-MGs, the activation/deactivation mechanisms of the plurality of pre-MGs may all be network device controlled activation/deactivation mechanisms. For example, when the first UE supports two activation/deactivation mechanisms of pre-MGs, as long as the deactivated MG list in any BWP configuration of the first UE includes an ID of any pre-MG in the plurality of pre-MGs, it may be considered that the plurality of pre-MGs all use network device controlled activation/deactivation mechanisms. Pre-MGs that are not included in the deactivated list are in an activated state by default.

As a more specific example, the first UE has a pre-MG 0 and a pre-MG 1, and the first UE is configured with four BWPs, namely, a BWP-1, a BWP-2, a BWP-3, and a BWP-4. In the four BWPs, deactivated MG lists in the configurations of the BWP-1 and the BWP-2 include a pre-MG 0, while other BWP configurations are not configured with a deactivated MG list or configured with a deactivated MG list that is empty. It may be considered that both the pre-MG 0 and the pre-MG 1 use network device controlled activation/deactivation mechanisms (even if the pre-MG 1 does not appear in a deactivated MG list of any BWP). Therefore, the pre-MG 0 is in a deactivated state when the BWP-1 and the BWP-2 are activated, and is in an activated state when other BWPs are activated, while the pre-MG 1 is in an activated state when each BWP is activated.

In some embodiments, the configuration information of the BWP may include a first deactivated MG set. MGs in the first deactivated MG set are the MGs when switching is made to the BWP (or when the BWP is in an activated state). If the first MG set includes one or more MGs in the plurality of pre-MGs, an activation/deactivation mechanism of the one or more MGs is a network device controlled activation/deactivation mechanism (without being affected by other MGs), and activation/deactivation mechanisms of remaining MGs other than the one or more MGs of the plurality of pre-MGs may be UE autonomous activation/deactivation mechanisms. For example, when the first UE supports two activation/deactivation mechanisms of pre-MGs, as long as the deactivated MG list in any BWP configuration of the first UE includes an ID of a pre-MG in the plurality of pre-MGs, it may be considered that the pre-MG uses a network device controlled activation/deactivation mechanism. Pre-MGs not included in the deactivated list may use UE autonomous activation/deactivation mechanisms.

As a more specific example, the first UE has a pre-MG 0 and a pre-MG 1, and the first UE is configured with four BWPs, namely, a BWP-1, a BWP-2, a BWP-3, and a BWP-4. In the four BWPs, deactivated MG lists in the configurations of the BWP-1 and the BWP-2 include a pre-MG 0, while other BWP configurations are not configured with a deactivated MG list or configured with a deactivated MG list that is empty. It may be considered that the pre-MG 0 uses a network device controlled activation/deactivation mechanism. The activation/deactivation mechanism of the pre-MG 1 is a UE autonomous activation/deactivation mechanism (because the pre-MG 1 does not appear in a deactivated list of any BWP). Therefore, the pre-MG 0 is in a deactivated state when the BWP-1 and the BWP-2 are activated, and is in an activated state when other BWPs are activated. In contrast, the UE can determine, based on information such as a relationship between a measurement object associated with the pre-MG 1 and each BWP, whether to activate the pre-MG 1.

In some embodiments, the first information mentioned above may include indication information sent by the network device and used to indicate the activation/deactivation mechanisms of the plurality of pre-MGs. The indication information may be, for example, indication signalling specifically used to indicate the activation/deactivation mechanisms of the plurality of pre-MGs.

In some embodiments, the plurality of pre-MGs correspond to indication information of a same activation/deactivation mechanism. The indication information may be signalling specifically used to indicate the plurality of pre-MGs. For example, the signalling may be configured via RRC. For example, the signalling may be NetworkControlPreGap. A value of NetworkControlPreGap is True/False, or a value of NetworkControlPreGap is 1/0. If the value of NetworkControlPreGap is True (or 1), it may indicate that the plurality of pre-MGs all use network device controlled activation/deactivation mechanisms. Alternatively, the signalling may be PreGapActivationMechanism. A value of PreGapActivationMechanism is selected from {NetworkControl, UEAutonomous}. The network device may indicate the activation/deactivation mechanisms of the plurality of pre-MGs by configuring the value of PreGapActivationMechanism.

In some embodiments, the plurality of pre-MGs may have indication information of respective corresponding activation/deactivation mechanisms. For example, the network device may configure the activation/deactivation mechanisms of the plurality of pre-MGs through a set of signalling. The set of signalling may be in a form of a bitmap or a sequence. For example, the set of signalling may be carried through RRC signalling. As a specific example, the set of signalling may be a sequence having a length equal to a quantity of configured pre-MGs. Each element in the sequence is PreGapActivationMechanism, and the value of PreGapActivationMechanism is selected from {NetworkControl, UEAutonomous}.

It should be understood that the solution of FIG. 5 may be combined with the solution of FIG. 4. For example, when the first-type MG is a pre-MG, and the pre-MG in the combined configuration includes a plurality of pre-MGs, the solution shown in FIG. 5 may be used to perform activation/deactivation operations on the plurality of pre-MGs. It should be further understood that the first information in the embodiment of FIG. 5 is different from the first information in the embodiment of FIG. 4. If the embodiments corresponding to FIG. 4 and FIG. 5 are combined with each other, the first information in FIG. 5 may be referred to as sixth information.

The foregoing describes in detail the method embodiments of this application with reference to FIG. 1 to FIG. 5. The following describes in detail apparatus embodiments of this application with reference to FIG. 6 to FIG. 10. It should be understood that the description of the method embodiments corresponds to the description of the apparatus embodiments, and therefore, for parts that are not described in detail, refer to the foregoing method embodiments.

FIG. 6 is a schematic diagram of a structure of UE according to an embodiment of this application. UE 600 shown in FIG. 6 includes a communications module 610. The communications module 610 may be configured to send first information to a network device. The first information is used to indicate a first capability of the UE, and the first capability is associated with a combined configuration of a first-type measurement gap and a second-type measurement gap.

In some embodiments, the first-type measurement gap includes a pre-configured measurement gap and/or a network controlled small gap, and the second-type measurement gap includes concurrent measurement gaps; or one of the first-type measurement gap and the second-type measurement gap includes a pre-configured measurement gap, and the other of the first-type measurement gap and the second-type measurement gap includes a network controlled small gap.

In some embodiments, the first information includes one or more of the following information: second information used to determine whether the combined configuration is executable for the UE; third information used to determine a quantity of first-type measurement gaps configured for the UE; fourth information used to determine the combined configuration of the first-type measurement gap and the second-type measurement gap; or fifth information used to determine whether to support configuring of the per-FR first-type measurement gap as the second-type measurement gap.

In some embodiments, the second information indicates one or more of the following information that the UE supports a pre-configured measurement gap; the UE supports a network controlled small gap; the UE supports concurrent measurement gaps; the UE supports both a pre-configured measurement gap and concurrent measurement gaps; the UE supports both a network controlled small gap and concurrent measurement gaps; or the UE supports all of a pre-configured measurement gap, a network controlled small gap, and concurrent measurement gaps.

In some embodiments, the combined configuration is a combined configuration of a pre-configured measurement gap, a network controlled small gap, and concurrent measurement gaps, and the second information is used to indicate one or more of the following information that the UE supports a plurality of measurement gaps, the plurality of measurement gaps include a first measurement gap and a second measurement gap, the first measurement gap is a pre-configured measurement gap, and the second measurement gap is a network controlled small gap; or the UE supports one or more measurement gaps, the one or more measurement gaps include a first measurement gap, the first measurement gap is a pre-configured measurement gap, and the first measurement gap is a network controlled small gap.

In some embodiments, the third information indicates a maximum quantity of first-type measurement gaps supported by the UE, where the maximum quantity is a per-UE maximum quantity, or the maximum quantity is a per-FR maximum quantity.

In some embodiments, the second-type measurement gap includes one or more configurations, and the fourth information is used to indicate a target configuration in the one or more configurations, where the target configuration is a configuration in which the UE supports introducing of the first-type measurement gap, or the target configuration is the combined configuration of the first-type measurement gap and the second-type measurement gap.

In some embodiments, the fourth information is further used to indicate one or more of the following information: the quantity of first-type measurement gaps; or information that the first-type measurement gap is a per-FR measurement gap and/or a per-UE measurement gap.

In some embodiments, if the UE does not support a per-FR measurement gap, measurement gaps in the target configuration are all per-UE measurement gaps.

In some embodiments, the target configuration includes a plurality of measurement gaps, and the fourth information indicates that some or all of the plurality of measurement gaps are first-type measurement gaps.

In some embodiments, the fourth information includes a plurality of pieces of indication information, the plurality of pieces of indication information have a one-to-one correspondence with the plurality of configurations, and each of the plurality of pieces of indication information is used to indicate whether a configuration corresponding to the piece of indication information belongs to the target configuration.

In some embodiments, the first-type measurement gap includes a network controlled small gap, the second-type measurement gap includes concurrent measurement gaps, and the fifth information is used to determine whether to support configuring of a per-FR network controlled small gap as concurrent measurement gaps.

FIG. 7 is a schematic diagram of a structure of a network device according to an embodiment of this application. A network device 700 shown in FIG. 7 includes a communications module 710. The communications module 710 may be configured to receive first information sent by first UE. The first information is used to indicate a first capability of the first UE, and the first capability is associated with a combined configuration of a first-type measurement gap and a second-type measurement gap.

In some embodiments, the first-type measurement gap includes a pre-configured measurement gap and/or a network controlled small gap, and the second-type measurement gap includes concurrent measurement gaps; or one of the first-type measurement gap and the second-type measurement gap includes a pre-configured measurement gap, and the other of the first-type measurement gap and the second-type measurement gap includes a network controlled small gap.

In some embodiments, the first information includes one or more of the following information: second information used to determine whether the combined configuration is executable for the first UE; third information used to determine a quantity of first-type measurement gaps configured for the first UE; fourth information used to determine the combined configuration of the first-type measurement gap and the second-type measurement gap; or fifth information used to determine whether to support configuring of the per-FR first-type measurement gap as the second-type measurement gap.

In some embodiments, the second information indicates one or more of the following information that the first UE supports a pre-configured measurement gap; the first UE supports a network controlled small gap; the first UE supports concurrent measurement gaps; the first UE supports both a pre-configured measurement gap and concurrent measurement gaps; the first UE supports both a network controlled small gap and concurrent measurement gaps; or the first UE supports all of a pre-configured measurement gap, a network controlled small gap, and concurrent measurement gaps.

In some embodiments, the combined configuration is a combined configuration of a pre-configured measurement gap, a network controlled small gap, and concurrent measurement gaps, and the second information is used to indicate one or more of the following information that the first UE supports a plurality of measurement gaps, the plurality of measurement gaps include a first measurement gap and a second measurement gap, the first measurement gap is a pre-configured measurement gap, and the second measurement gap is a network controlled small gap; or the first UE supports one or more measurement gaps, the one or more measurement gaps include a first measurement gap, the first measurement gap is a pre-configured measurement gap, and the first measurement gap is a network controlled small gap.

In some embodiments, the third information indicates a maximum quantity of first-type measurement gaps supported by the first UE, where the maximum quantity is a per-UE maximum quantity, or the maximum quantity is a per-FR maximum quantity.

In some embodiments, the second-type measurement gap includes one or more configurations, and the fourth information is used to indicate a target configuration in the one or more configurations, where the target configuration is a configuration in which the first UE supports introducing of the first-type measurement gap, or the target configuration is the combined configuration of the first-type measurement gap and the second-type measurement gap.

In some embodiments, the fourth information is further used to indicate one or more of the following information: the quantity of first-type measurement gaps; or information that the first-type measurement gap is a per-FR measurement gap and/or a per-UE measurement gap.

In some embodiments, if the first UE does not support a per-FR measurement gap, measurement gaps in the target configuration are all per-UE measurement gaps.

In some embodiments, the target configuration includes a plurality of measurement gaps, and the fourth information indicates that some or all of the plurality of measurement gaps are first-type measurement gaps.

In some embodiments, the fourth information includes a plurality of pieces of indication information, the plurality of pieces of indication information have a one-to-one correspondence with the plurality of configurations, and each of the plurality of pieces of indication information is used to indicate whether a configuration corresponding to the piece of indication information belongs to the target configuration.

In some embodiments, the first-type measurement gap includes a network controlled small gap, the second-type measurement gap includes concurrent measurement gaps, and the fifth information is used to determine whether to support configuring of a per-FR network controlled small gap as concurrent measurement gaps.

FIG. 8 is a schematic diagram of a structure of UE according to another embodiment of this application. UE 800 shown in FIG. 8 includes a communications module 810. The communications module 810 may be configured to receive first information. The first UE has a plurality of pre-configured measurement gaps, and the first information is used to determine activation/deactivation mechanisms of the plurality of pre-configured measurement gaps, where the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

In some embodiments, the first information includes one or more of the following information: configuration information for a BWP; or indication information sent by a network device and used to indicate the activation/deactivation mechanisms of the plurality of pre-configured measurement gaps.

In some embodiments, the configuration information for the BWP includes a first deactivated measurement gap set; and if the first measurement gap set includes one or more measurement gaps of the plurality of pre-configured measurement gaps, the activation/deactivation mechanisms of the plurality of pre-configured measurement gaps are all network device controlled activation/deactivation mechanisms; or if the first measurement gap set includes one or more measurement gaps of the plurality of pre-configured measurement gaps, an activation/deactivation mechanism of the one or more measurement gaps is a network device controlled activation/deactivation mechanism, and activation/deactivation mechanisms of remaining measurement gaps other than the one or more measurement gaps of the plurality of pre-configured measurement gaps are UE autonomous activation/deactivation mechanisms.

In some embodiments, the plurality of pre-configured measurement gaps correspond to indication information of a same activation/deactivation mechanism, or the plurality of pre-configured measurement gaps have indication information of respective corresponding activation/deactivation mechanisms.

FIG. 9 is a schematic diagram of a structure of a network device according to an embodiment of this application. A network device 900 shown in FIG. 9 includes a communications module 910. The communications module 910 may be configured to send first information to first UE. The first UE has a plurality of pre-configured measurement gaps, and the first information is used to determine activation/deactivation mechanisms of the plurality of pre-configured measurement gaps. The activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

In some embodiments, the first information includes one or more of the following information: configuration information for a BWP; or indication information sent by a network device and used to indicate the activation/deactivation mechanisms of the plurality of pre-configured measurement gaps.

In some embodiments, the configuration information for the BWP includes a first deactivated measurement gap set; and if the first measurement gap set includes one or more measurement gaps of the plurality of pre-configured measurement gaps, the activation/deactivation mechanisms of the plurality of pre-configured measurement gaps are all network device controlled activation/deactivation mechanisms; or if the first measurement gap set includes one or more measurement gaps of the plurality of pre-configured measurement gaps, an activation/deactivation mechanism of the one or more measurement gaps is a network device controlled activation/deactivation mechanism, and activation/deactivation mechanisms of remaining measurement gaps other than the one or more measurement gaps of the plurality of pre-configured measurement gaps are UE autonomous activation/deactivation mechanisms.

In some embodiments, the plurality of pre-configured measurement gaps correspond to indication information of a same activation/deactivation mechanism, or the plurality of pre-configured measurement gaps have indication information of respective corresponding activation/deactivation mechanisms.

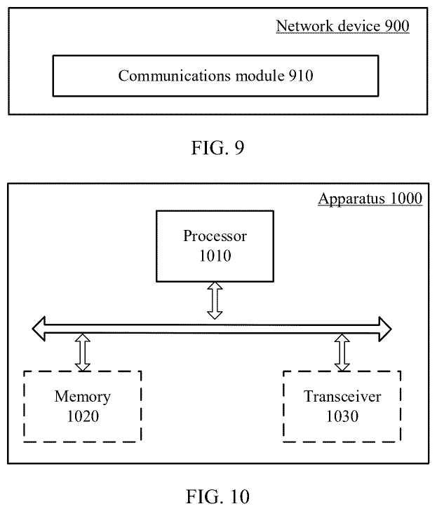

FIG. 10 is a schematic diagram of a structure of an apparatus according to an embodiment of this application. The dashed lines in FIG. 10 indicate that the unit or module is optional. The apparatus 1000 may be configured to implement the methods described in the foregoing method embodiments. The apparatus 1000 may be a chip, UE, or a network device. The UE and the network device may be respectively the first UE mentioned above and the network device interacting with the first UE.

The apparatus 1000 may include one or more processors 1010. The processor 1010 may support the apparatus 1000 in implementing the methods described in the foregoing method embodiments. The processor 1010 may be a general-purpose processor or a dedicated processor. For example, the processor may be a central processing unit (CPU). Alternatively, the processor 1010 may be another general-purpose processor, a digital signal processor (DSP), an application-specific integrated circuit (ASIC), a field-programmable gate array (FPGA) or another programmable logic device, a discrete gate or transistor logic device, a discrete hardware component, or the like. The general-purpose processor may be a microprocessor, or the processor may be any conventional processor or the like.

The apparatus 1000 may further include one or more memories 1020. The memory 1020 stores a program. The program may be executed by the processor 1010, so that the processor 1010 performs the methods described in the foregoing method embodiments. The memory 1020 may be separate from the processor 1010 or may be integrated into the processor 1010.

The apparatus 1000 may further include a transceiver 1030. The processor 1010 may communicate with another device or chip by using the transceiver 1030. For example, the processor 1010 may transmit data to and receive data from another device or chip by using the transceiver 1030.

In some embodiments, the apparatus 1000 may be located in the UE in FIG. 6 or FIG. 8. The communications module in the UE may correspond to the transceiver 1030 in the apparatus 1000. Alternatively, functions of the communications module may be implemented by the transceiver 1030 in the apparatus 1000 under the control of the processor 1010.

In some embodiments, the apparatus 1000 may be located in the network device in FIG. 7 or FIG. 9. The communications module in the network device may correspond to the transceiver 1030 in the apparatus 1000. Alternatively, functions of the communications module may be implemented by the transceiver 1030 in the apparatus 1000 under the control of the processor 1010.

An embodiment of this application further provides a computer-readable storage medium for storing a program. The computer-readable storage medium may be applied to the UE or the network device provided in embodiments of this application, and the program causes a computer to perform the methods performed by the UE or the network device in various embodiments of this application.

An embodiment of this application further provides a computer program product. The computer program product includes a program. The computer program product may be applied to the UE or the network device provided in embodiments of this application, and the program causes a computer to perform the methods performed by the UE or the network device in various embodiments of this application.

An embodiment of this application further provides a computer program. The computer program may be applied to the UE or the network device provided in embodiments of this application, and the computer program causes a computer to perform the methods performed by the UE or the network device in various embodiments of this application.

It should be understood that, the “indication” mentioned in embodiments of this application may be a direct indication or an indirect indication, or indicate an association. For example, “A indicates B” may mean that A indicates B directly, where for example, B may be obtained by using A; may mean that A indicates B indirectly, where for example, A indicates C, and B may be obtained by using C; or may mean that there is an association between A and B.

In the description of embodiments of this application, the term “corresponding” may mean that there is a direct or indirect correspondence between two elements, or that there is an association between two elements, or that there is a relationship of “indicating” and “being indicated”, “configuring” and “being configured”, or the like.

“Configured” in embodiments of this application may include being configured by using at least one of a system message, radio resource control (RRC) signalling, or a medium access control element (MAC CE).

In some embodiments of this application, “predefined” or “preset” may be implemented by pre-storing corresponding codes, tables, or other forms that can be used to indicate related information in devices (for example, including the UE and the network device), and a specific implementation thereof is not limited in this application. For example, being predefined may refer to being defined in a protocol.

In some embodiments of this application, the “protocol” may be a standard protocol in the communication field, which may include, for example, an LTE protocol, an NR protocol, and a related protocol applied to a future communications system. This is not limited in this application.

It should be understood that, in this specification, the term “and/or” is merely an association relationship that describes associated objects, and represents that there may be three relationships. For example, A and/or B may represent three cases: only A exists, both A and B exist, and only B exists. In addition, the character “/” herein generally indicates an “or” relationship between the associated objects.

It should be understood that, in embodiments of this application, sequence numbers of the foregoing processes do not mean execution sequences. The execution sequences of the processes should be determined according to functions and internal logic of the processes, and should not be construed as any limitation on the implementation processes of embodiments of this application.

In several embodiments provided in this application, it should be understood that the disclosed system, apparatus, and method may be implemented in other manners. For example, the described apparatus embodiments are merely examples. For example, the unit division is merely logical function division and may be other division in actual implementation. For example, a plurality of units or components may be combined or integrated into another system, or some features may be ignored or not executed. In addition, the displayed or discussed mutual couplings or direct couplings or communication connections may be implemented as indirect couplings or communication connections through some interfaces, apparatuses or units, and may be implemented in electrical, mechanical, or other forms.

The units described as separate parts may be or may not be physically separate, and parts displayed as units may be or may not be physical units, and may be at one location, or may be distributed on a plurality of network elements. Some or all of the units may be selected according to actual requirements to achieve the objective of the solutions of embodiments.

In addition, functional units in embodiments of this application may be integrated into one processing unit, or each of the units may exist alone physically, or two or more units may be integrated into one unit.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of this application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, radio, and microwave) manner. The computer-readable storage medium may be any usable medium readable by the computer, or a data storage device, such as a server or a data center, integrating one or more usable media. The usable medium may be a magnetic medium (for example, a floppy disk, a hard disk, or a magnetic tape), an optical medium (for example, a digital video disc (DVD)), a semiconductor medium (for example, a solid state drive (SSD)), or the like.

The foregoing descriptions are merely specific implementations of this application, but the protection scope of this application is not limited thereto. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A wireless communication method, comprising:
sending, by first user equipment, first information to a network device, wherein the first information is used to indicate a first capability of the first user equipment, and the first capability is associated with a combined configuration of a first-type measurement gap and a second-type measurement gap.

2. The method according to claim 1, wherein
the first-type measurement gap comprises a pre-configured measurement gap and/or a network controlled small gap, and the second-type measurement gap comprises concurrent measurement gaps; or
one of the first-type measurement gap and the second-type measurement gap comprises a pre-configured measurement gap, and the other of the first-type measurement gap and the second-type measurement gap comprises a network controlled small gap.

3. The method according to claim 1, wherein the first information comprises one or more of the following information:
second information used to determine whether the combined configuration is executable for the first user equipment;
third information used to determine a quantity of first-type measurement gaps configured for the first user equipment;
fourth information used to determine the combined configuration of the first-type measurement gap and the second-type measurement gap; or
fifth information used to determine whether to support configuring of the per frequency range first-type measurement gap as the second-type measurement gap, wherein the first-type measurement gap comprises a network controlled small gap, the second-type measurement gap comprises concurrent measurement gaps.

4. The method according to claim 2, wherein
in a case that a gap combination configuration identity of the concurrent measurement gaps is 0, the quantity of measurement gaps for FR1 is 2, the quantity of measurement gaps for FR2 is 1, and the quantity of measurement gaps for UE is 0;
in a case that a gap combination configuration identity of the concurrent measurement gaps is 1, the quantity of measurement gaps for FR1 is 1, the quantity of measurement gaps for FR2 is 2, and the quantity of measurement gaps for UE is 0;
in a case that a gap combination configuration identity of the concurrent measurement gaps is 2, the quantity of measurement gaps for FR1 is 0, the quantity of measurement gaps for FR2 is 0, and the quantity of measurement gaps for UE is 2;
in a case that a gap combination configuration identity of the concurrent measurement gaps is 3, the quantity of measurement gaps for FR1 is 1, the quantity of measurement gaps for FR2 is 0, and the quantity of measurement gaps for UE is 1;
in a case that a gap combination configuration identity of the concurrent measurement gaps is 4, the quantity of measurement gaps for FR1 is 0, the quantity of measurement gaps for FR2 is 1, and the quantity of measurement gaps for UE is 1;
in a case that a gap combination configuration identity of the concurrent measurement gaps is 5, the quantity of measurement gaps for FR1 is 1, the quantity of measurement gaps for FR2 is 1, and the quantity of measurement gaps for UE is 1;
in a case that a gap combination configuration identity of the concurrent measurement gaps is 6, the quantity of measurement gaps for FR1 is 2, the quantity of measurement gaps for FR2 is 0, and the quantity of measurement gaps for UE is 0; or
in a case that a gap combination configuration identity of the concurrent measurement gaps is 7, the quantity of measurement gaps for FR1 is 0, the quantity of measurement gaps for FR2 is 2, and the quantity of measurement gaps for UE is 0.

5. User equipment, comprising a memory and a processor, wherein the memory is configured to store a program, and the processor is configured to invoke the program from the memory, to cause the user equipment to perform following operation:
transmitting first information to a network device, wherein the first information is used to indicate a first capability of the user equipment, and the first capability is associated with a combined configuration of a first-type measurement gap and a second-type measurement gap.

6. The user equipment according to claim 5, wherein
the first-type measurement gap comprises a pre-configured measurement gap and/or a network controlled small gap, and the second-type measurement gap comprises concurrent measurement gaps; or
one of the first-type measurement gap and the second-type measurement gap comprises a pre-configured measurement gap, and the other of the first-type measurement gap and the second-type measurement gap comprises a network controlled small gap.

7. The user equipment according to claim 5, wherein the first information comprises one or more of the following information:
second information used to determine whether the combined configuration is executable for the user equipment;
third information used to determine a quantity of first-type measurement gaps configured for the user equipment;
fourth information used to determine the combined configuration of the first-type measurement gap and the second-type measurement gap; or
fifth information used to determine whether to support configuring of the per frequency range first-type measurement gap as the second-type measurement gap, wherein the first-type measurement gap comprises a network controlled small gap, the second-type measurement gap comprises concurrent measurement gaps.

8. The user equipment according to claim 7, wherein the second information indicates one or more of the following information that
the user equipment supports a pre-configured measurement gap;
the user equipment supports a network controlled small gap;
the user equipment supports concurrent measurement gaps;
the user equipment supports both a pre-configured measurement gap and concurrent measurement gaps;
the user equipment supports both a network controlled small gap and concurrent measurement gaps; or
the user equipment supports all of a pre-configured measurement gap, a network controlled small gap, and concurrent measurement gaps.

9. The user equipment according to claim 6, wherein
in a case that a gap combination configuration identity of the concurrent measurement gaps is 0, the quantity of measurement gaps for FR1 is 2, the quantity of measurement gaps for FR2 is 1, and the quantity of measurement gaps for UE is 0;
in a case that a gap combination configuration identity of the concurrent measurement gaps is 1, the quantity of measurement gaps for FR1 is 1, the quantity of measurement gaps for FR2 is 2, and the quantity of measurement gaps for UE is 0;
in a case that a gap combination configuration identity of the concurrent measurement gaps is 2, the quantity of measurement gaps for FR1 is 0, the quantity of measurement gaps for FR2 is 0, and the quantity of measurement gaps for UE is 2;
in a case that a gap combination configuration identity of the concurrent measurement gaps is 3, the quantity of measurement gaps for FR1 is 1, the quantity of measurement gaps for FR2 is 0, and the quantity of measurement gaps for UE is 1;
in a case that a gap combination configuration identity of the concurrent measurement gaps is 4, the quantity of measurement gaps for FR1 is 0, the quantity of measurement gaps for FR2 is 1, and the quantity of measurement gaps for UE is 1;
in a case that a gap combination configuration identity of the concurrent measurement gaps is 5, the quantity of measurement gaps for FR1 is 1, the quantity of measurement gaps for FR2 is 1, and the quantity of measurement gaps for UE is 1;
in a case that a gap combination configuration identity of the concurrent measurement gaps is 6, the quantity of measurement gaps for FR1 is 2, the quantity of measurement gaps for FR2 is 0, and the quantity of measurement gaps for UE is 0; or
in a case that a gap combination configuration identity of the concurrent measurement gaps is 7, the quantity of measurement gaps for FR1 is 0, the quantity of measurement gaps for FR2 is 2, and the quantity of measurement gaps for UE is 0.

10. The user equipment according to claim 9, wherein in a case that the network controlled small gap does not support positioning reference signal measurement and the gap combination configuration identity of the concurrent measurement gaps is 3/4/5, measurement gap for UE in the gap combination configuration is not replaced with the network controlled small gap.

11. The user equipment according to claim 5, wherein the user equipment further performs the following operation:
receiving sixth information, wherein the first user equipment has a plurality of pre-configured measurement gaps, and the sixth information is used to determine activation/deactivation mechanisms of the plurality of pre-configured measurement gaps, wherein
the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

12. The user equipment according to claim 11, wherein the sixth information comprises one or more of the following information:
configuration information for a bandwidth part; or
indication information sent by a network device and used to indicate the activation/deactivation mechanisms of the plurality of pre-configured measurement gaps.

13. A network device, comprising a memory and a processor, wherein the memory is configured to store a program, and the processor is configured to invoke the program from the memory, to cause the network device to perform following operation:
receiving first information sent by first user equipment, wherein the first information is used to indicate a first capability of the first user equipment, and the first capability is associated with a combined configuration of a first-type measurement gap and a second-type measurement gap.

14. The network device according to claim 13, wherein
the first-type measurement gap comprises a pre-configured measurement gap and/or a network controlled small gap, and the second-type measurement gap comprises concurrent measurement gaps; or
one of the first-type measurement gap and the second-type measurement gap comprises a pre-configured measurement gap, and the other of the first-type measurement gap and the second-type measurement gap comprises a network controlled small gap.

15. The network device according to claim 13, wherein the first information comprises one or more of the following information:
second information used to determine whether the combined configuration is executable for the first user equipment;
third information used to determine a quantity of first-type measurement gaps configured for the first user equipment;
fourth information used to determine the combined configuration of the first-type measurement gap and the second-type measurement gap; or
fifth information used to determine whether to support configuring of the per frequency range first-type measurement gap as the second-type measurement gap, wherein the first-type measurement gap comprises a network controlled small gap, the second-type measurement gap comprises concurrent measurement gaps.

16. The network device according to claim 15, wherein the second information indicates one or more of the following information that
the first user equipment supports a pre-configured measurement gap;
the first user equipment supports a network controlled small gap;
the first user equipment supports concurrent measurement gaps;
the first user equipment supports both a pre-configured measurement gap and concurrent measurement gaps;
the first user equipment supports both a network controlled small gap and concurrent measurement gaps; or
the first user equipment supports all of a pre-configured measurement gap, a network controlled small gap, and concurrent measurement gaps.

17. The network device according to claim 14, wherein
in a case that a gap combination configuration identity of the concurrent measurement gaps is 0, the quantity of measurement gaps for each FR1 is 2, the quantity of measurement gaps for each FR2 is 1, and the quantity of measurement gaps for each UE is 0;
in a case that a gap combination configuration identity of the concurrent measurement gaps is 1, the quantity of measurement gaps for each FR1 is 1, the quantity of measurement gaps for each FR2 is 2, and the quantity of measurement gaps for each UE is 0;
in a case that a gap combination configuration identity of the concurrent measurement gaps is 2, the quantity of measurement gaps for each FR1 is 0, the quantity of measurement gaps for each FR2 is 0, and the quantity of measurement gaps for each UE is 2;
in a case that a gap combination configuration identity of the concurrent measurement gaps is 3, the quantity of measurement gaps for each FR1 is 1, the quantity of measurement gaps for each FR2 is 0, and the quantity of measurement gaps for each UE is 1;
in a case that a gap combination configuration identity of the concurrent measurement gaps is 4, the quantity of measurement gaps for each FR1 is 0, the quantity of measurement gaps for each FR2 is 1, and the quantity of measurement gaps for each UE is 1;
in a case that a gap combination configuration identity of the concurrent measurement gaps is 5, the quantity of measurement gaps for each FR1 is 1, the quantity of measurement gaps for each FR2 is 1, and the quantity of measurement gaps for each UE is 1;
in a case that a gap combination configuration identity of the concurrent measurement gaps is 6, the quantity of measurement gaps for each FR1 is 2, the quantity of measurement gaps for each FR2 is 0, and the quantity of measurement gaps for each UE is 0; or
in a case that a gap combination configuration identity of the concurrent measurement gaps is 7, the quantity of measurement gaps for each FR1 is 0, the quantity of measurement gaps for each FR2 is 2, and the quantity of measurement gaps for each UE is 0.

18. The network device according to claim 17, wherein in a case that the network controlled small gap does not support positioning reference signal measurement and the gap combination configuration identity of the concurrent measurement gaps is 3/4/5, measurement gap for each UE in the gap combination configuration is not replaced with the network controlled small gap.

19. The network device according to claim 13, wherein the network device further performs following operation:
transmitting sixth information to first user equipment, wherein the first user equipment has a plurality of pre-configured measurement gaps, and the sixth information is used to determine activation/deactivation mechanisms of the plurality of pre-configured measurement gaps, wherein
the activation/deactivation mechanisms of the plurality of pre-configured measurement gaps are the same activation/deactivation mechanism, or the activation/deactivation mechanisms of the plurality of pre-configured measurement gaps are different activation/deactivation mechanisms.

20. The network device according to claim 19, wherein the sixth information comprises one or more of the following information:
configuration information for a bandwidth part; or
indication information sent by a network device and used to indicate the activation/deactivation mechanisms of the plurality of pre-configured measurement gaps.
